(19) United States
(12) Patent Application Publication
(10) Pub. No.: US 2011/0036857 A1
(43) Pub. Date: Feb. 17, 2011

(54) Distribution Method for Low-Sulfur Fuels Products

(75) Inventors: Paul William Bessonette, Deptford, NJ (US); Stephen Sanjaya Pathak, Toronto (CA)

Correspondence Address: ExxonMobil Research & Engineering Company, P.O. Box 900, 1545 Route 22 East, Annandale, NJ, 08801-0900, US

(73) Assignee: ExxonMobil Research and Engineering Company, Annandale, NJ (US)

(21) Appl. No.: 12/851,810

(22) Filed: Aug. 6, 2010

Related U.S. Application Data
(60) Provisional application No. 61/273,949, filed on Aug. 11, 2009.

(51) Int. Cl. B67D 7/04; B08B 9/00

(52) U.S. Cl. 222/1; 134/22.1; 137/561 R

(57) ABSTRACT

Method for transporting low and ultra-low sulfur fuel products using common, non-dedicated distribution systems also used to transport and distribute high-sulfur fuel products.

### CROSS-REFERENCE TO RELATED APPLICATIONS

This is a Non-Provisional Application that claims priority to U.S. Provisional Application Ser. No. 61/273,949 filed Aug. 11, 2009, which is herein incorporated by reference in its entirety.

### FIELD OF THE INVENTION

The present invention relates to methods for the transport and distribution of low and ultra-low sulfur fuel products.

### BACKGROUND OF THE INVENTION

Government regulations restricting the total sulfur content of many fuel products will severely reduce the amount of sulfur pick-up that can be tolerated in the distribution system from the point of production/importation to the point-of-sale. Common distribution practices are not sufficient to transport/deliver on-spec low and ultra-low sulfur fuels, especially because many components of the distribution system are non-dedicated; i.e., common portions of the distribution system are used to transport high-sulfur fuels products and low-sulfur fuels products in sequence.

Components in the system for the distribution and transport of high-sulfur content fuel which would be common in the system for the distribution and transport of low and ultra-low sulfur fuel, and which are included in the scope of the present invention, are, without limitation, pipelines, tank trucks, tank railcars, marine barges and other marine compartmented transports, storage and delivery equipment, product loading arms, tank truck delivery hoses, storage tanks, product distribution storage tanks (e.g., service station tanks), product delivery hoses and tankage, feed discharge hoses, the pumps employed to move the product into, out of and through any of the aforementioned pipes, tanks, hoses, etc.

Government regulations impose a maximum total sulfur specification on fuels products, where the maximum specification may be different depending on the type of fuel; e.g., on-road diesel, off-road diesel, etc. Government sulfur specifications for some fuels products in Canada and the United States are or will become significantly tighter at the point-of-sale.

Fuels products are transported from the point of production/importation to the point-of-sale through a distribution system, the components of which typically include pipelines, terminal tanks, trucks, rail transport, marine transport, service station/cardlock tanks, loading arms and lines, and truck hoses. Components of the distribution system may or may not be dedicated to a particular fuel product, depending on economic and practical considerations. An example of a dedicated distribution system component could be terminal tanks, which are usually dedicated to a single fuel product type only.

However, there are many examples of non-dedicated distribution system components. Fuels product pipelines are usually not dedicated to a single product—different fuels products of varying sulfur content are typically transported through a common pipeline in a batch sequence. The installation of a series of fuels products pipelines, each dedicated to a single fuel product, would be economically and practically prohibitive. Compartments in fuel delivery trucks are typically not dedicated to a particular fuel; change-of-service situations are common in the operation of truck compartments, where one type of fuel is loaded into a compartment, delivered to its destination, and another fuel of a different type is subsequently loaded into the same compartment. Furthermore, common loading arms and lines at terminals can be used for the transport and loading of different fuels products, and common hoses can be utilized for delivery of different fuels products from trucks.

With components of the distribution system being used to transport several different fuels products in sequence, cross-contamination between different fuels will naturally occur to some degree. If a low-sulfur fuel is sequenced to follow a higher-sulfur fuel in a common section of the distribution system, contamination of the low-sulfur fuel with even a small amount of the higher-sulfur fuel can unduly elevate the sulfur content of the low-sulfur fuel. For example, residual high-sulfur material left behind from a previous load in a truck compartment would contaminate a subsequently loaded volume of lower sulfur product and raise its total overall sulfur content. A further example is the cross-contamination that will occur at the interface between a low-sulfur product and an adjacently sequenced higher-sulfur product in the common pipeline.

With the relatively high maximum total sulfur limits that currently exist, or recently existed, for fuels products at the point-of-sale, sulfur limits at the point of production or importation can relatively easily be set at a level well below the never-to-exceed limits to allow for substantial sulfur pick-up in the distribution system from the refinery to the point-of-sale. For example, under recent never-to-exceed sulfur limits of 500 mg/kg, on-road diesel fuel produced meeting a refinery gate maximum sulfur specification of 450 mg/kg could experience up to 50 mg/kg of sulfur pick-up in the distribution system and still be within the never-to-exceed limit at the point of sale of 500 mg/kg.

However, government regulations will substantially reduce or have recently substantially reduced the never-to-exceed maximum sulfur limits at the point-of-sale for many fuel products. With the significantly tighter sulfur limits, the tolerance for sulfur pick-up in the distribution system from the point of production/importation to the point-of-sale will be severely restricted. For example, diesel fuel produced for on-road applications (ULSD) has recently been subjected to a never-to-exceed total sulfur limit at the point-of-sale of 15 mg/kg. Thus, depending on the sulfur content of the ULSD at the point of production, the amount of sulfur pick-up in the fuel which could be tolerated in the distribution system would have to be less than the never-to-exceed limit at the point-of-sale of 15 mg/kg. In most cases, the tolerance for sulfur pick-up in the distribution system is expected to be much less than this; e.g., less than 5 mg/kg.

Methods are needed for the distribution of low-sulfur fuels products such that they are transported from the point of production/importation to the point-of-sale within the significantly reduced tolerance for sulfur pick-up in the distribution system that will occur or has recently occurred as a result of government regulations. Methods which would allow for the continued use of a distribution system with common components for transport of low-sulfur and higher-sulfur fuels products would be particularly advantageous, thus avoiding the costly installation of separate distribution systems, each dedicated to a particular fuel.

Commercial methods are currently available and practiced for the distribution of fuels governed by maximum sulfur content regulations which are significantly higher than the sulfur levels that will be mandated or have recently been mandated. For example, change-of-service guidelines are in place for switch loading between different fuel products in truck compartments. Other guidelines define the size and handling of the interface between batches of different fuels products in a pipeline. When one of the fuel products involved is jet fuel, these current methods are especially important to ensure that the product quality of jet fuel is maintained. However, considering other fuel products (e.g., diesel, gasoline, furnace fuel), these methods are designed to ensure that sulfur pick-up in the distribution system is maintained within allowed tolerances. In view of the more stringent government-regulated maximum sulfur limits, the tolerance for sulfur pick-up in the distribution system for many fuels products will be or has been significantly reduced relative to previous tolerances. Standard distribution practices were not designed to maintain sulfur pick-up to within the severely restricted limits resulting from recent or upcoming future regulations.

### DESCRIPTION OF THE FIGURE

FIG. 1 is a plot for a specific example of F, the volume of ultra-low sulfur fuel flush pumped into the loading arm versus In (S-S^{ref}) wherein S is the arm outlet sulfur level and S^{ref} is the sulfur concentration of the ultra-low sulfur fuel sample showing a best fill line from linear regression analysis.

### DESCRIPTION OF THE INVENTION

The present invention comprises methods for the transport and distribution of low-sulfur fuels products such that they are transported from the point of production/importation to the point-of-sale within the significantly tightened and reduced tolerance for sulfur pick-up in the distribution system that will occur or have occurred as a result of government regulations. These methods allow for the continued use of a distribution system with common components, currently used to handle high-sulfur fuels for transport of low-sulfur and higher sulfur fuels products; the uneconomic alternative would be the costly installation of separate distribution systems, each dedicated to a particular fuel.

It has been found that low and ultra-low sulfur fuels can be transported through a transport and distribution system containing components common to the transport and distribution of high sulfur fuels.

### SUMMARY OF THE INVENTION

It has been found that to store, transport and distribute ultra-low sulfur (ULS) fuel, particularly ultra-low sulfur (ULS) diesel fuel, through a storage, transport and distribution system containing components common to the storage, transport and distribution of high sulfur fuels, the common component(s) must be either drained to dryness or flushed with a sufficient sacrificial volume of ultra-low sulfur fuel which is then segregated as being off-spec, to clean out the common component(s), after which low and ultra-low sulfur fuel which is on-specification can be stored, transported and distributed through such flushed common component(s) with an acceptable level of sulfur pick-up, if any.

### DETAILED DESCRIPTION OF THE INVENTION

It has been found that truck, marine (barge or tanker ship) and rail car components must be drained dry prior to loading of low and ultra-low sulfur fuel during change-of-service situations. Components which are drained dry include fuel storage compartments, fuel delivery hoses, pumps, manifolds and meter systems. Such drain-dry procedures require the complete emptying of the component of any prior load of higher-sulfur material. Such draining is performed while the component to be drained is on a level surface or an even heel, or angled in the direction of the product drain to ensure that all the prior load material is removed from the component. Any hose and/or manifolds and/or pumps and/or meters associated and employed in the use of the drained component should similarly be drained dry.

It is unexpected that a drain-dry procedure is sufficient to cleanse and ready the compartments previously used to transport higher-sulfur content fuel for the transport and distribution of ultra-low sulfur fuel still meeting sulfur content specification limits.

Similarly, it is unexpected that draining the manifolds, hoses, pumps and meters associated with such storage/transport compartments would be sufficient to cleanse and ready them for transport and delivery of ultra-low sulfur fuel still meeting sulfur content specifications. Previously change-of-service or transition from one fuel to another required a minimum fluid volume of 90 liters for tank trucks regardless of compartment size.

If the hose, manifold, pump and meter system is not or cannot be drained dry, then they must be flushed with a sufficient volume of sacrificial ultra-low sulfur fuel as flush material which after being used as sacrificial flush material no longer meets ultra-low sulfur fuel sulfur content specification and is segregated from the delivered on-spec product. The amount of sacrificial flush material employed depends on the total fill volume of such hose, manifold, pump and meter system involved as well as the sulfur content of the previous high-sulfur content fuel delivered and the amount of such higher-sulfur content fuel material present as residue on the hose, manifold, pump and meter system. If the system was not drained dry, then cleansing of loading arms and lines can be accomplished through use of a sacrificial flush volume. Such a flush volume can be determined by reference, for example, to tables such as Tables 1a, 1b, 1c, and 1d which relate sulfur pick-up in the delivered fuel based on delivered volume ranging from 500 to 5000 liters of delivered fuel to the flush volume in the hose, manifold, pump and meter system (the hose/manifold/pump/meter system evaluated in the following table has a nominal filled volume of about 100 liters) and to the preceding load sulfur content for various delivered volumes.

TABLE 1(a)
Sulfur Pick-Up
Assume 500 L Delivery

| Flush | Preceding Load Sulfur (mg/kg) | | | | | |
|---|---|---|---|---|---|---|
| Volume (L) | 500 | 1000 | 2000 | 3000 | 4000 | 5000 |
| 100 | 2.98 | 5.97 | 11.94 | 17.90 | 23.87 | 29.84 |
| 125 | 1.48 | 2.96 | 5.92 | 8.88 | 11.85 | 14.81 |
| 150 | 0.83 | 1.67 | 3.34 | 5.00 | 6.67 | 8.34 |
| 175 | 0.51 | 1.03 | 2.05 | 3.08 | 4.10 | 5.13 |
| 200 | 0.34 | 0.67 | 1.34 | 2.02 | 2.69 | 3.36 |
| 225 | 0.23 | 0.46 | 0.92 | 1.39 | 1.85 | 2.31 |
| 250 | 0.17 | 0.33 | 0.66 | 0.99 | 1.32 | 1.65 |
| 275 | 0.12 | 0.24 | 0.49 | 0.73 | 0.97 | 1.22 |
| 300 | 0.09 | 0.18 | 0.37 | 0.55 | 0.74 | 0.92 |
| 325 | 0.07 | 0.14 | 0.28 | 0.43 | 0.57 | 0.71 |
| 350 | 0.06 | 0.11 | 0.22 | 0.33 | 0.45 | 0.56 |
| 375 | 0.04 | 0.09 | 0.18 | 0.27 | 0.36 | 0.45 |
| 400 | 0.04 | 0.07 | 0.14 | 0.22 | 0.29 | 0.36 |
| 425 | 0.03 | 0.06 | 0.12 | 0.18 | 0.24 | 0.30 |
| 450 | 0.02 | 0.05 | 0.10 | 0.15 | 0.20 | 0.25 |
| 475 | 0.02 | 0.04 | 0.08 | 0.12 | 0.16 | 0.20 |
| 500 | 0.02 | 0.03 | 0.07 | 0.10 | 0.14 | 0.17 |

TABLE 1(b)
Sulfur Pick-Up
Assume 1000 L Delivery

| Flush | Preceding Load Sulfur (mg/kg) | | | | | |
|---|---|---|---|---|---|---|
| Volume (L) | 500 | 1000 | 2000 | 3000 | 4000 | 5000 |
| 100 | 1.50 | 2.99 | 5.99 | 8.89 | 11.97 | 14.97 |
| 125 | 0.74 | 1.49 | 2.98 | 4.47 | 5.96 | 7.44 |
| 150 | 0.42 | 0.84 | 1.68 | 2.52 | 3.37 | 4.21 |
| 175 | 0.26 | 0.52 | 1.04 | 1.56 | 2.08 | 2.60 |
| 200 | 0.17 | 0.34 | 0.68 | 1.02 | 1.37 | 1.71 |
| 225 | 0.12 | 0.24 | 0.47 | 0.71 | 0.94 | 1.18 |
| 250 | 0.08 | 0.17 | 0.34 | 0.51 | 0.68 | 0.85 |
| 275 | 0.06 | 0.13 | 0.25 | 0.38 | 0.50 | 0.63 |
| 300 | 0.05 | 0.10 | 0.19 | 0.29 | 0.38 | 0.48 |
| 325 | 0.04 | 0.07 | 0.15 | 0.22 | 0.30 | 0.37 |
| 350 | 0.03 | 0.06 | 0.12 | 0.18 | 0.23 | 0.29 |
| 375 | 0.02 | 0.05 | 0.09 | 0.14 | 0.19 | 0.24 |
| 400 | 0.02 | 0.04 | 0.08 | 0.12 | 0.15 | 0.19 |
| 425 | 0.02 | 0.03 | 0.06 | 0.10 | 0.13 | 0.16 |
| 450 | 0.01 | 0.03 | 0.05 | 0.08 | 0.11 | 0.13 |
| 475 | 0.01 | 0.02 | 0.04 | 0.07 | 0.09 | 0.11 |
| 500 | 0.01 | 0.02 | 0.04 | 0.06 | 0.08 | 0.09 |

TABLE 1(c)
Sulfur Pick-Up
Assume 2000 L Delivery

| Flush | Preceding Load Sulfur (mg/kg) | | | | | |
|---|---|---|---|---|---|---|
| Volume (L) | 500 | 1000 | 2000 | 3000 | 4000 | 5000 |
| 100 | 0.75 | 1.50 | 2.99 | 4.49 | 5.99 | 7.49 |
| 125 | 0.37 | 0.75 | 1.49 | 2.24 | 2.98 | 3.73 |
| 150 | 0.21 | 0.42 | 0.84 | 1.26 | 1.69 | 2.11 |
| 175 | 0.13 | 0.26 | 0.52 | 0.78 | 1.04 | 1.30 |
| 200 | 0.09 | 0.17 | 0.34 | 0.51 | 0.69 | 0.86 |
| 225 | 0.06 | 0.12 | 0.24 | 0.36 | 0.47 | 0.59 |
| 250 | 0.04 | 0.09 | 0.17 | 0.26 | 0.34 | 0.43 |
| 275 | 0.03 | 0.06 | 0.13 | 0.19 | 0.25 | 0.32 |
| 300 | 0.02 | 0.05 | 0.10 | 0.14 | 0.19 | 0.24 |
| 325 | 0.02 | 0.05 | 0.10 | 0.14 | 0.19 | 0.24 |
| 350 | 0.01 | 0.03 | 0.06 | 0.09 | 0.12 | 0.15 |
| 375 | 0.01 | 0.02 | 0.05 | 0.07 | 0.10 | 0.12 |
| 400 | 0.01 | 0.02 | 0.04 | 0.06 | 0.08 | 0.10 |
| 425 | 0.01 | 0.02 | 0.03 | 0.05 | 0.06 | 0.08 |
| 450 | 0.01 | 0.01 | 0.03 | 0.04 | 0.05 | 0.07 |
| 475 | 0.01 | 0.01 | 0.02 | 0.03 | 0.05 | 0.06 |
| 500 | 0.01 | 0.01 | 0.02 | 0.03 | 0.04 | 0.05 |

TABLE 1(d)
Sulfur Pick-Up
Assume 5000 L Delivery

| Flush | Preceding Load Sulfur (mg/kg) | | | | | |
|---|---|---|---|---|---|---|
| Volume (L) | 500 | 1000 | 2000 | 3000 | 4000 | 5000 |
| 100 | 0.30 | 0.60 | 1.20 | 1.80 | 2.40 | 3.00 |
| 125 | 0.15 | 0.30 | 0.60 | 0.89 | 1.19 | 1.49 |
| 150 | 0.08 | 0.17 | 0.34 | 0.51 | 0.67 | 0.84 |
| 175 | 0.05 | 0.10 | 0.21 | 0.31 | 0.42 | 0.52 |
| 200 | 0.03 | 0.07 | 0.14 | 0.21 | 0.27 | 0.34 |
| 225 | 0.02 | 0.05 | 0.09 | 0.14 | 0.19 | 0.24 |
| 250 | 0.02 | 0.03 | 0.07 | 0.10 | 0.14 | 0.17 |
| 275 | 0.01 | 0.03 | 0.05 | 0.08 | 0.10 | 0.13 |
| 300 | 0.01 | 0.02 | 0.04 | 0.06 | 0.08 | 0.10 |
| 325 | 0.01 | 0.02 | 0.03 | 0.05 | 0.06 | 0.08 |
| 350 | 0.01 | 0.01 | 0.02 | 0.04 | 0.05 | 0.06 |
| 375 | 0.00 | 0.01 | 0.02 | 0.03 | 0.04 | 0.05 |
| 400 | 0.00 | 0.01 | 0.01 | 0.02 | 0.03 | 0.04 |
| 425 | 0.00 | 0.01 | 0.01 | 0.02 | 0.03 | 0.03 |
| 450 | 0.00 | 0.01 | 0.01 | 0.02 | 0.02 | 0.03 |
| 475 | 0.00 | 0.00 | 0.01 | 0.01 | 0.02 | 0.02 |
| 500 | 0.00 | 0.00 | 0.01 | 0.01 | 0.02 | 0.02 |

Tables such as Tables 1a, 1b, 1e and 1d can be used to determine the minimum fuel volume needed to flush out an about 100 liter volume hose/pump/manifold/meter system previously used to deliver fuel having sulfur content of from e.g. 500 to 5000 mg/kg, the tables showing the sulfur pick-up for delivery of ultra-low sulfur (ULS) fuel, in this instance diesel ranging from 500 to 5000 liters delivered fuel following flushes of the system with from 100 to 500 liters of flush ULS diesel of a particular sulfur content level. Thus, for example, in Table 1b for a 1000 liter delivery of ULS diesel, flushing the 100 liter volume hose/manifold/pump/meter system previously used to deliver a fuel containing e.g. 1000 mg sulfur/kg of fuel with about 300 liters of ULS diesel of about 20 to 21 mg S/kg before delivery of the fuel results in the delivered fuel having a sulfur pick-up of 0.10 mg sulfur/kg.

The practitioner can readily generate his own set of tables for his own particular hose/manifold/pump/meter system (of different fill volume) to reflect the flush volume needed to meet a specified sulfur pick-up level in different volumes of delivered fuel transported through different fill volume hose/manifold/pump/meter systems previously used to deliver high sulfur content fuels as follows:

A series of runs are performed whereby specific different volumes of flush ULS fuel (referred to as ULS diesel hereafter) of particular sulfur content are passed through the specific drained-dry hose/manifold/pump/meter system of interest (hereinafter “system”). The sulfur content of the high sulfur content fuel previously delivered through the system as well as the sulfur content of the ULS diesel fuel to be used as system flush and as the delivered fuel are determined as is the fill volume of the system. This is because the following calculation and resulting tables are accurate only for the particular systems for which they are generated.

Following passage of each specific different incremental volume of flush ULS diesel through the system, the sulfur content of that incremental flushed volume is determined. The sulfur pick-up is calculated by subtracting the initial sulfur content of the ULS diesel before the flush (S_{(ULSD)}) from the sulfur content of each incremental ULS diesel volume following the flush through the system (S_{(system outlet)}) using the following equation:

Sulfur pick-up=S_{(system outlet)}−S_{(ULSD)}

Any observed sulfur pickup is the result of contamination by the previously delivered higher sulfur product. The effective amount of contamination by the higher sulfur product (Vol % _{(initial fill)}) can be calculated using the following equation:

$$Vol {\%}_{( initial fill )} = 100 \times [ \frac{{P}_{( system outlet )} {S}_{( system outlet )} - {P}_{( ULSD )} {S}_{ULSD}}{{P}_{( initial fill )} {S}_{( initial fill )} - {P}_{( ULSD )} {S}_{( ULSD )}} ]$$

where P_{(initial fill)} is the nominal density (kg/L) of the high sulfur fuel previously in this system;
   P_{(system outlet)} is the measured density (kg/L) of the actual samples from the system after measured specific volumes of ULS diesel have been passed through the system;
   S_{(initial fill)} is the nominal sulfur content (mg/kg) of the high sulfur fuel previously in the system;
   S_{(system outlet)} is the measured sulfur content (mg/kg) of the samples of fuel from the system after measured specific volumes of ULS diesel have been passed through the system;
   P_{(ULSD)} is the density (kg/L) of the Ultra-Low Sulfur Diesel;
   S_{(ULSD)} is the sulfur content (mg/kg) of the Ultra-Low Sulfur Diesel.

These vol % contamination values for the different incremental flush volumes are then used to calculate sulfur pick-up values for different real or projected/presumed high sulfur content fuels (of different S_{(initial fill)} values) which some day will or can be handled in the system, using the following equation:

$$Sulfur pickup = \frac{\begin{matrix}{P}_{( initiali fill )} {S}_{( initial fill )} Vol {\%}_{( initial fill )} + \\ {P}_{( ULSD )} {S}_{( ULSD )} ( 100 - Vol {\%}_{( initial fill )} )\end{matrix}}{100 \times {P}_{( system outlet )}} - {S}_{ULSD}$$

Thus, while the actual runs may be conducted on a system which actually previously held, e.g. a 1500 mg sulfur/kg high sulfur fuel, the vol % sulfur contamination values so generated can be used to then calculate sulfur pick-up values for different high sulfur content fuels be it an actual fuel (sulfur content of, e.g. 2300 mg S/kg) or for a proposed series of fuels of hypothetical sulfur content, e.g. a series of fuels having 500, 1000, 2000, 3000, 4000 and 5000 mg S/kg, thus generating a matrix of values which can be used in as the basis for extrapolation or interpolation.

These values are plotted as sulfur pick-up versus ULS diesel flush volumes to generate a series of best-fit curves of the form y=C S_{(initial fill)} x^{p}, for each value of S_{(initial fill)}, where y is the sulfur pickup observed after a volume x has passed through the hose. Best-fit curve parameters C and p are determined by mathematical techniques well known to those skilled in the art, which define each curve.

The average sulfur pick-up for different volumes of ULS diesel delivered through the particular system which previously held high sulfur content fuels and was flushed with different incremental volumes of ULS diesel can then be determined using the formula:

$$Average sulfur pick \text{-} up ( mg \text{/} kg ) = \frac{{CS}_{( initial fill )}}{V ( p + 1 )} [ \begin{matrix}{( F + V )}^{p + 1} - \\ {F}^{p + 1}\end{matrix} ]$$

where F is the volume in liters of ULS diesel used to flush the system
   V is the volume of ULS diesel to be delivered
   S_{(initial fill)} is the sulfur content in mg/kg of the high sulfur content fuel previously in the system
   C is the best-fit constant, previously identified
   P is curve parameter P, previously identified

Thus, after only a few actual measurements the practitioner is in possession of sufficient information to generate a table or series of tables (such as

Table 1a, 1b, 1c and 1d) showing the expected sulfur pick-up for different volumes of delivered ULS diesel delivered through his particular system which previously delivered high sulfur content fuel of any given high sulfur content following flushing using various volumes of ULS diesel fuel of specific sulfur content. For delivered volumes different from those recorded in the table or for previously delivered high sulfur content fuels of sulfur content not in the table(s), the practitioner can easily interpolate or extrapolate as necessary.

Different tables would have to be generated for systems of different fill volumes.

It is not always practical to drain dry large scale loading arms or transport lines used to load fuel products into transport and delivery systems or into storage systems from the point of manufacture.

In such instances loading arms or transport lines containing the predecessor high sulfur content products must be flushed with ultra-low sulfur fuel to cleanse and ready such loading arms or lines. The ultra-low sulfur fuel used to flush such loading arms or lines will move the prior higher content sulfur product out of the loading arm or line as well as wash the walls of the loading arm or line.

When such loading arms or lines have been switched or transitioned from one fuel or product to a different fuel or product (not ultra-low sulfur fuel), current practice calls for flushing such loading arms or lines with the transitioning fuel or product.

It has been found, however, that to transition or switch transport lines or loading arms or lines in a fuel rack used to fill fuel components in tank trucks, rail cars or marine transport systems (e.g., barge) from high sulfur fuel to ultra-low sulfur fuel, considerably more ultra-low sulfur fuel must be employed as the sacrificial flush volume if the transport line, loading arm or line is to be sufficiently clean to transport and deliver ultra-low sulfur fuel meeting sulfur content specifications (with minimum sulfur pick-up).

### Example—Single Product Line Testing

Three test runs were performed to help determine how much ultra-low sulfur fuel flush was required for a single product loading arm to ready such loading arm to deliver ultra-low sulfur fuel from the discharge end of the arm with negligible contamination from a prior line fill of higher sulfur product. At the start of each test, a sample of the prior load arm fill was taken from the discharge end of the arm as a reference. The test load arm was then put into ultra-low sulfur fuel service, and (known sulfur content) samples were taken from the discharge end of the loading arm (nozzle) as a function of the volume of ultra-low sulfur fuel pumped into the loading arm. An ultra-low sulfur fuel sample was also taken for comparison purposes. Each sample was measured for total sulfur concentration. Details of each test and the sulfur results for each sample taken are provided separately in Tables 2(a), (b), and (c).

TABLE 2(a)
Test #1
Prior Load: 1300 mg S/kg fuel
Estimated Line Fill: 3300 L

| Volume Ultra-Low Sulfur | | Sulfur Concentration |
|---|---|---|
| Fuel Pumped into Arm | | at Nozzle (mg/kg) |
| 0 | L (prior load) | 1300 |
| 2000 | L | 313 |
| 2900 | L | 312 |
| 3500 | L | 310 |
| 4500 | L | 96.9 |
| 6000 | L | 42.9 |
| 6700 | L | 36.6 |
| 7800 | L | 39.0 |
| 8500 | L | 32.0 |
| 9500 | L | 31.6 |

| | |
|---|---|
| Ultra-Low Sulfur Fuel Pump | 19.7 |

TABLE 2(b)
Test #2
Prior Load: Fuel Having 340 mg S/kg Fuel
Estimated Line Fill: 5000 L

| Volume Ultra-Low Sulfur | | Sulfur Concentration |
|---|---|---|
| Fuel Pumped into Arm | | at Nozzle (mg/kg) |
| 0 | L (prior load) | 340 |
| 5000 | L | 32.0 |
| 6000 | L | 22.0 |
| 7000 | L | 19.9 |
| 8000 | L | 19.6 |
| 9000 | L | 19.6 |
| 10000 | L | 19.5 |

| | |
|---|---|
| Ultra-Low Sulfur Fuel Pump | 19.7 |

TABLE 2(c)
Test #3
Prior Load: 264 mg S/kg Fuel
Estimated Line Fill: 90 L

| Volume Ultra-Low Sulfur | | Sulfur Concentration |
|---|---|---|
| Fuel Pumped into Arm | | at Nozzle (mg/kg) |
| 0 | L (prior load) | 264 |
| 20 | L | 263 |
| 80 | L | 211 |
| 150 | L | 23.5 |
| 500 | L | 20.5 |

| | |
|---|---|
| Ultra-Low Sulfur Fuel Pump | 19.7 |

In the first test run, the sulfur level of the fuel material sampled from the discharge end of the loading arm is still unacceptably higher than the ultra-low sulfur fuel pump sample even after 9500 L (almost 3 line-fill volumes) of ultra-low sulfur fuel have been pumped into the loading arm. Because samples were taken from the end of the loading arm, the 9500 L sample effectively measures the sulfur level of the outlet material after two line fills of material have been pushed through the entire length of the loading arm, the third line fill still being in the loading arm itself.

It is desirable to extrapolate how much ultra-low sulfur fuel would have to be pumped into the loading arm in test run #1 to deliver ultra-low sulfur fuel product from the end of the arm with an acceptable sulfur level. To assist in this extrapolation, a model was developed which assumes that the drop in outlet sulfur level with increasing ultra-low sulfur level flush volume is proportional to the difference between the outlet sulfur level and the reference ultra-low sulfur fuel level; i.e.,

$$\frac{d S}{d F} = kx ( S - {S}_{ref} ) \qquad Equation 1$$

where S is the arm outlet sulfur level
   F is the volume of ultra-low sulfur fuel flush pumped into the loading arm
   S_{ref} is the sulfur concentration of the ultra-low sulfur fuel sample
   k is the constant of proportionality
      Rearranging Equation 1 gives

$$\int \frac{d S}{S - {S}_{ref}} = \int k d F . \qquad Equation 2$$

Performing the integration in Equation 2 gives

ln(S−S_{ref})=kF+C Equation 3

or

S−S_{ref}=A e^{kF} Equation 4

where C is a constant of integration
A is a constant=e^{c}.

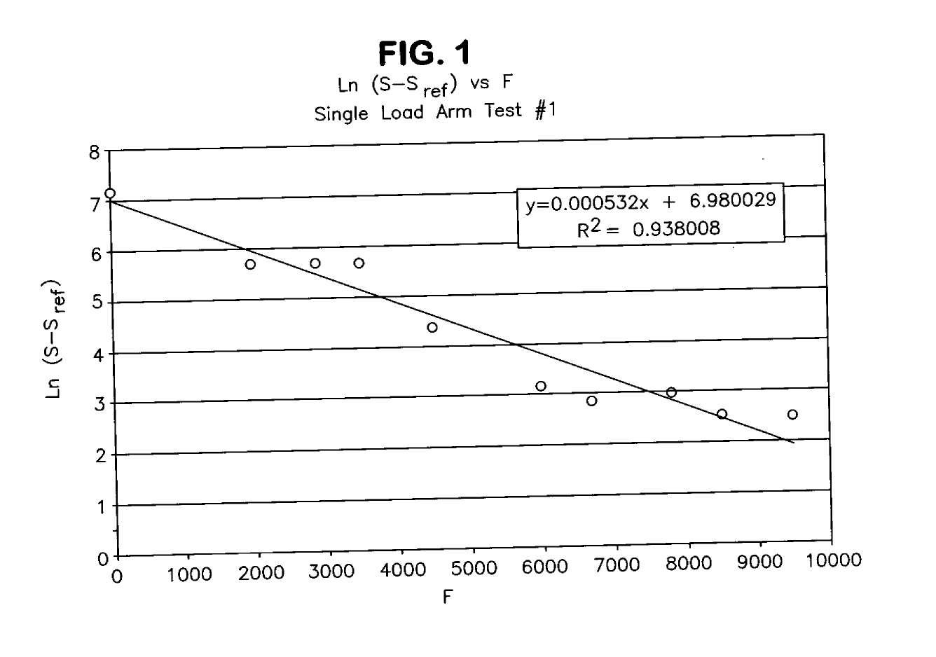

According to Equation 3, a plot of ln(S−S_{ref}) versus F should be linear with slope k and a y-intercept of C. Such a plot for the test #1 data is provided in FIG. 1, where the best-fit line is also shown, obtained from a linear regression analysis. FIG. 1 shows that the model fits the data fairly well; the coefficient of determination for the fit (R²) is 0.938.

The parameter (S−S_{ref}) is the sulfur pick-up relative to the ultra-low sulfur fuel reference sample. If a loading arm outlet sulfur pick-up of less than 0.5 mg/kg is considered acceptable, the best-fit line shown in FIG. 1 can be used to determine the required flush volume to achieve this target. This extrapolation procedure results in a required ultra-low sulfur fuel volume of 14400 L to be pumped into this particular line test #1 which previously contained 3300 liters of product having a sulfur content of 1300 ppm in order to deliver ultra-low sulfur fuel at the outlet with a sulfur pick-up <0.5 mg/kg.

For test run #2 (estimated line fill volume of 5000 liters), the data in Table 2(b) shows that negligible sulfur pick-up is observed at the arm outlet after 7000 L of ultra-low sulfur fuel has been pumped into the arm. This corresponds to roughly 2000 L of material expelled at the arm outlet, sent to separate storage as being off-spec with too high a level of sulfur pick-up, which is much less than the amount of flush volume required in test run #1. This is related to the fact that the initial sulfur level in run #1 was about four times higher than the sulfur level in run #2.

After several line fills of ultra-low sulfur fuel flush were passed through the ˜90 L volume line used in test run #3, the sulfur pick-up of the material taken near the arm outlet was still greater than 0.5 mg/kg, although only slightly so.

Thus, a method is taught for determining the sacrificial flush volume of ultra-low sulfur fuel needed to cleanse and prepare specific undrained transport lines, loading arms, line or hose/manifold/pump/meter systems, hereinafter collectively referred to as delivery lines in the following text and appended claims, for the transport and delivery of ultra-low sulfur fuel meeting low sulfur content specifications relating initial line fill sulfur content, ultra-low sulfur fuel sulfur content and level of sulfur pick-up, said method comprising:
(a) determining the delivery line fill volume;
(b) determining the sulfur content of the high sulfur content material currently in the delivery line;
(c) determining the ultra-low sulfur fuel sulfur content (S_{ref});
(d) measuring the sulfur content (S) at the delivery outlet of the delivery line initially and at a number of different volumes (F) of ultra-low sulfur fuel pumped into and through the delivery line;
(e) plotting ln(S−S_{ref}) versus F;
(f) calculating a best-fit line;
(g) reading from the best-fit line on the plot the flush volume of ultra-low sulfur fuel needed to meet a predetermined acceptable sulfur pick-up value in the fuel at the point of discharge of the delivery line;
(h) repeating steps (a) to (f) for different high sulfur content materials, different sulfur content ultra-low sulfur fuels and different sulfur pick-up levels;
(i) generating charts for the specific delivery line showing the volumes of different sulfur content ultra-low sulfur diesel fuel needed to flush high sulfur content fuels of different sulfur content from the delivery line to meet target sulfur pick-up values at the delivery outlet point of the delivery line; and
(j) using the charts to determine the volume of ultra-low sulfur diesel needed to flush the particular delivery line of high sulfur material, extrapolating or interpolating as necessary to account for different sulfur contents of the high sulfur material, the ultra-low sulfur diesel and the desired sulfur pick-up value.

By this method, employing a minimum of test runs, wherein the delivery line has been filled with high sulfur fuels of different sulfur contents, and flushed with ultra-low sulfur fuel of different sulfur contents to achieve different sulfur pick-up levels, charts or tables can be generated by the practitioner for the specific delivery line enabling him to predict the sacrificial flush volume of specific sulfur content ultra-low sulfur fuel needed to cleanse and ready the specific volume delivery line in response to various initial fill sulfur contents, ultra-low sulfur fuel sulfur contents and acceptable sulfur pick-up values. For high sulfur fuels of sulfur content not previously measured or ultra-low sulfur fuels of previously unconsidered low sulfur content, the practitioner can extrapolate or interpolate from the data on the chart or table to predict the flush volume needed and then employ the measurement data recorded during the actual flush to generate an additional chart or table, thus expanding the predicting database.

The use of insufficient volumes of sacrificial flush material can leave higher sulfur content material in the loading arms or lines. Care must be taken to ensure that the loading arms and lines are clean or that the sulfur content of any material left in the line when delivery of ultra-low sulfur product is begun is sufficiently low that only an acceptable level of sulfur pick-up is encountered; i.e., that the residual sulfur level is low enough so that upon dilution the level of sulfur pick-up in the ultra-low sulfur fuel, as delivered through the loading arm or line, is within an acceptable limit.

Storage tanks or service station tanks can be conditioned for receipt and eventual point-of-sale delivery of ultra-low sulfur fuel meeting the target sulfur specification by over time drawing down the volume of fuel currently contained in the tank and filling with ultra-low sulfur fuel to effect a dilution. Drawing down the volume of the tank to a heel level of about 25% by sale of the fuel as conventional or merely low-sulfur fuel followed by compete fill with ultra-low sulfur fuel and repeating for three to four fills will result in the fuel at the end of the third or fourth switchover fill being on-spec, with minimal sulfur pick-up, a fuel suitable for distribution as meeting the point-of-sale target ultra-low sulfur fuel sulfur content specification.

Alternatively, the storage tank or service station tank can be conditioned by drawing the volume of the tank to a heel level of about 40 to 60% followed by complete fill with ultra-low sulfur fuel, repeating this at least three times; after the third delivery, draw the tank down to a heel of 10% of full capacity and then fill with ultra-low sulfur fuel.

A preferred method for delivering ultra-low sulfur fuel involves using a multi-compartment delivery vessel, which could be tank truck, ship or rail car, which has at least two separate compartments and hose/pump/meter systems, one of which can be dedicated to high-sulfur product while a second is dedicated to low-sulfur product. In this embodiment, at the fuel loading point (e.g., a fuel terminal), compartments which are to be filled with low-sulfur product and which previously held high-sulfur product are pumped dry through the hose/pump/meter system dedicated to high-sulfur product, preferably while the vessel is level. The compartment is then filled with low-sulfur product and an additional small volume (e.g., 20 L for a tank truck) of low-sulfur product is flushed out of the compartment through the hose/pump/meter system dedicated to high-sulfur product. This step clears/flushes the line from the compartment to the junction point in the common manifold system, suitably preparing the system for eventual delivery of low-sulfur product, uncontaminated with high-sulfur product, through the hose/pump/meter system dedicated to low-sulfur product. Additional compartments may be filled with low-sulfur product in this manner while remaining compartments are filled with high-sulfur product without additional flush volume. On-spec deliveries of low-sulfur product are then made through the hose/pump/meter system dedicated to low-sulfur product while delivery of high-sulfur product is made through the hose/pump/meter system dedicated to high-sulfur product. Change-of-service of a truck compartment which previously held high-sulfur product to low-sulfur product service is accomplished through the pump-dry, low-sulfur fill, small-volume flush procedure just described.

This method allows a multicompartment vessel to carry high and low-sulfur products in different compartments and make multiple on-spec deliveries of low-sulfur product without additional flushing after leaving the loading point. The amount of flush volume required at the loading point by this method for a vessel with separate hose/pump/meters dedicated to high and low-sulfur products is significantly less than the product volume which would be required to flush a single hose for a low-sulfur product delivery following a high-sulfur product delivery. This not only provides meaningful cost savings, but also significantly reduces the amount of off-spec flush volume which has to be managed. Most importantly, use of this method increases flexibility and avoids the need for trucks dedicated solely to low-sulfur product service, providing significant cost savings.

What is claimed is:

1. A method for storing, transporting and distributing ultra-low sulfur fuel through a storage, transport and distribution system containing components common to the storage, transport and delivery of high sulfur fuels, said method comprising draining to dryness the storage, transport and distribution components previously in contact with the high sulfur fuel prior to using any such component for the storage, transport or distribution of the ultra-low sulfur fuel.

2. The method of claim 1 wherein the storage, transport or distribution component is a delivery vessel selected from tank truck, barge, tanker ship, rail car, a delivery line, manifold or any part thereof previously in contact with high sulfur fuel.

3. The method of claim 1 or 2 further comprising rinsing the storage, transport or distribution component with a volume of ultra-low sulfur fuel to flush out any residual high sulfur fuel remaining in the component, the resulting flush material being segregated from the ultra-low sulfur fuel.

4. The method of claim 2 wherein the delivery line is the hose/pump/meter assembly on the delivery vessel and the ultra-low sulfur fuel used to rinse the delivery line is taken from a cleaned compartment of its associated delivery vessel.

5. A method for cleaning delivery lines involved in transporting and delivering ultra-low sulfur fuel from the point of manufacture to the point of storage or distribution when the draining of such delivery lines is not practical, said method comprising:
(a) determining the delivery line fill volume;
(b) determining the sulfur content of the high sulfur content material currently in the delivery line;
(c) determining the ultra-low sulfur fuel sulfur content (S_{ref});
(d) measuring the sulfur content (S) at the delivery outlet of the delivery line initially and at a number of different volumes (F) of ultra-low sulfur fuel pumped into and through the delivery line;
(e) plotting ln(S−S_{ref}) versus F;
(t) calculating a best-fit line;
(g) reading from the best-fit line on the plot the flush volume of ultra-low sulfur fuel needed to meet a predetermined acceptable sulfur pick-up value in the fuel at the point of discharge of the delivery line;
(h) repeating steps (a) to (f) for different high sulfur content materials, different sulfur content ultra-low sulfur fuels and different sulfur pick-up levels;
(i) generating charts or tables for the specific delivery line showing the volumes of different sulfur content ultra-low sulfur fuel needed to flush high sulfur content fuels of different sulfur content from the delivery line to meet target sulfur pick-up values at the delivery outlet point of the delivery line; and
(j) using the charts or tables to determine the volume of ultra-low sulfur fuel needed to flush the particular delivery line of high sulfur material, extrapolating or interpolating as necessary to account for different sulfur contents of the high sulfur material, the ultra-low sulfur fuel and the desired sulfur pick-up value.

6. A method for purging storage tanks for eventual storage of ultra-low sulfur fuel meeting the sulfur specification for point-of-sale delivery of fuel from such storage tank, said method comprising:
(a) drawing down the volume of fuel currently in said tank to a heel of about 25% or less of the total volume of the storage tank;
(b) filling the tank completely with ultra-low sulfur fuel;
(c) again drawing down the volume of fuel in the storage tank to a heel of about 25% or less of the total volume, selling such fuel as conventional or low-sulfur fuel;
(d) repeating steps (b) and (c) at least twice again; and
(e) filling the tank with ultra-low sulfur fuel and dispensing from said storage tank ultra-low sulfur fuel meeting target point-of-delivery sulfur content for said fuel.

7. A method for purging storage tanks for eventual storage of ultra-low sulfur fuel meeting the sulfur specification for point-of-sale delivery of ultra-low sulfur fuel from such storage tank, said method comprising:
(a) drawing down the volume of fuel currently in said tank to a heel of about 40 to 60% of the total volume;
(b) filling the tank completely with ultra-low sulfur fuel;
(c) repeating steps (a) and (b) at least three times;
(d) drawing down the volume of fuel in the tank to a heel of about 10% of the total volume; and
(e) filling the tank completely with ultra-low sulfur fuel and dispensing from said tank ultra-low sulfur fuel meeting the point-of-sale target ultra-low sulfur fuel sulfur content specification.

8. A method for multiple on-spec deliveries of low sulfur fuel using a multi-compartment delivery vehicle wherein one or more of the compartments contain low sulfur fuel and the other compartments contain product(s) of higher sulfur content, whereby the delivery vessel is equipped with at least two separate hose/pump/meter systems, one of which can be dedicated to high-sulfur product while a second is dedicated to low-sulfur product, said method comprising:
(a) at the fuel loading point (e.g., a fuel terminal), compartments which are to be filled with low-sulfur product and previously held high-sulfur product are pumped dry through the hose/pump/meter system dedicated to high-sulfur product (preferably while the vessel is level);
(b) the compartment is then filled with low-sulfur product and an additional small volume of low-sulfur product is flushed out of the compartment through the hose/pump/meter system dedicated to high-sulfur product, which clears/flushes the line from the compartment to the junction point in the common manifold system, suitably preparing the system for eventual delivery of low-sulfur product, uncontaminated with high-sulfur product, through the hose/pump/meter system dedicated to low-sulfur product;
(c) additional compartments may be filled with low-sulfur product in this manner while remaining compartments are filled with high-sulfur product without additional flush volume;
(d) on-spec deliveries of low-sulfur product are then made through the hose/pump/meter system dedicated to low-sulfur product while delivery of high-sulfur product is made through the hose/pump/meter system dedicated to high-sulfur product.
